(19) United States
(12) Patent Application Publication
(10) Pub. No.: US 2019/0190403 A1
(43) Pub. Date: Jun. 20, 2019

(54) SYSTEM-CONNECTED INVERTER DEVICE AND METHOD FOR OPERATING SAME

(71) Applicant: TOSHIBA MITSUBISHI-ELECTRIC INDUSTRIAL SYSTEMS CORPORATION, Chuo-ku (JP)

(72) Inventors: Motoko FURUKAWA, Chuo (JP); Masahiro KINOSHITA, Chuo (JP)

(73) Assignee: TOSHIBA MITSUBISHI-ELECTRIC INDUSTRIAL SYSTEMS CORPORATION, Chuo-ku (JP)

(21) Appl. No.: 16/324,737

(22) PCT Filed: Aug. 16, 2016
(86) PCT No.: PCT/JP2016/073928

§ 371 Date: Feb. 11, 2019

(51) Int. Cl. H02M 7/5387; H02M 7/487; H02M 1/08

(52) U.S. Cl. CPC H02M 7/53871; H02M 2001/0054; H02M 1/08; H02M 7/487

(57) ABSTRACT

According to an embodiment of the invention, a system-connected inverter device that includes a three-level inverter, a voltage sensor, and a controller is provided. The three-level inverter includes multiple switching elements, is connected to an electric power system of alternating current and a direct current power supply, converts direct current power supplied from the direct current power supply from direct current power into alternating current power by an ON/OFF of the multiple switching elements, and supplies the alternating current power to the electric power system. The voltage sensor detects an alternating current voltage of the electric power system. The controller detects an instantaneous voltage drop of the electric power system based on a detection result of the voltage sensor, and controls the converting by the three-level inverter from the direct current power into the alternating current power by controlling operations of the multiple switching elements using a unipolar modulation method in a state in which the instantaneous voltage drop is not detected and by controlling the operations of the multiple switching elements using a dipolar modulation method in a state in which the instantaneous voltage drop is detected.

### FIELD

Embodiments described herein relate generally to a system-connected inverter device and method for operating same.

### BACKGROUND ART

There is a system-connected inverter device that converts direct current power into alternating current power and supplies the alternating current power after the conversion to an alternating current power system. In the system-connected inverter device, a three-level inverter is used; and a three-level voltage is output. The three-level inverter includes multiple switching elements. For example, the ON/OFF of each of the switching elements of the three-level inverter is controlled by a three-level PWM modulation method. Thereby, the three-level voltage is output. Compared to a two-level inverter, the output voltage waveform can approach a sine wave better in the three-level inverter. For example, the harmonic components can be suppressed; and downsizing of the filter on the output side can be realized.

As three-level PWM modulation methods, for example, a unipolar modulation method in which a positive pulse-form voltage or a negative pulse-form voltage is output continuously, a dipolar modulation method in which positive and negative pulse-form voltages are output alternately via a zero voltage, etc., are known (e.g., Non-Patent Literature 1). Compared to the unipolar modulation method, the waveform of the output voltage can approach a sine wave better in the dipolar modulation method. On the other hand, compared to the dipolar modulation method, the switching loss that accompanies the ON/OFF of each of the switching elements can be suppressed in the unipolar modulation method in the case where the direct current voltage of the steady-state operation is high.

In system-connected inverter devices in recent years, a FRT (Fault Ride Through) function is desirable in which the operation is continued without an abnormal stop even in the case where a temporary alternating current power system fault such as an instantaneous voltage drop or the like occurs.

In the case where the unipolar modulation method is used in a system-connected inverter device having a FRT function, low-order harmonics undesirably occur easily in the case where an instantaneous voltage drop occurs and the modulation factor decreases. In other words, the output voltage waveform undesirably distorts in the FRT operation interval. In the case where the dipolar modulation method is used, the occurrence of harmonics in the FRT operation interval can be suppressed; but, on the other hand, the switching loss of the steady-state operation undesirably increases.

Therefore, in the system-connected inverter device, it is desirable to obtain a more stable operation while suppressing the switching loss.

### PRIOR ART DOCUMENTS

### Non-Patent Literature

### [Non-Patent Literature 1]

Fukuda, Shoji and Suzuki, Kunio “Harmonic Evaluation of Carrier-Based Multi-Level PWM Methods,” Institute of Electrical Engineers of Japan Transactions on Industry Applications, Vol. 119-D, No. 6, 1999, p. 769-775

### SUMMARY OF INVENTION

### Problem to be Solved by the Invention

Embodiments of the invention provide a system-connected inverter device and a method for operating the system-connected inverter device in which the switching loss is suppressed and the operation is stable.

### Means for Solving the Problem

According to an embodiment of the invention, a system-connected inverter device that includes a three-level inverter, a voltage sensor, and a controller is provided. The three-level inverter includes multiple switching elements, is connected to an electric power system of alternating current and a direct current power supply, converts direct current power supplied from the direct current power supply from direct current power into alternating current power by an ON/OFF of the multiple switching elements, and supplies the alternating current power to the electric power system. The voltage sensor detects an alternating current voltage of the electric power system. The controller detects an instantaneous voltage drop of the electric power system based on a detection result of the voltage sensor, and controls the converting by the three-level inverter from the direct current power into the alternating current power by controlling operations of the multiple switching elements using a unipolar modulation method in a state in which the instantaneous voltage drop is not detected and by controlling the operations of the multiple switching elements using a dipolar modulation method in a state in which the instantaneous voltage drop is detected.

### Effects of the Invention

According to embodiments of the invention, a system-connected inverter device and a method for operating the system-connected inverter device are provided in which the switching loss is suppressed and the operation is stable.

### BRIEF DESCRIPTION OF DRAWINGS

FIG. 1 is a block diagram schematically illustrating a system-connected inverter device according to an embodiment.

FIG. 2A and FIG. 2B are graphs schematically illustrating an example of the operation of the PWM controller according to the embodiment.

FIG. 3 is a flowchart schematically illustrating an example of the method for operating the system-connected inverter device according to the embodiment.

FIG. 4 is a block diagram schematically illustrating an example of the three-level inverter according to the embodiment.

FIG. 5 is a block diagram schematically illustrating another example of the three-level inverter according to the embodiment.

### DESCRIPTION OF EMBODIMENTS

Embodiments will now be described with reference to the drawings.

The drawings are schematic or conceptual; and the relationships between the thicknesses and widths of portions, the proportions of sizes between portions, etc., are not necessarily the same as the actual values thereof. Further, there are also cases where the dimensions and/or the proportions are illustrated differently between the drawings, even in the case where the same portion is illustrated.

In this specification and each drawing, components similar to ones described in reference to an antecedent drawing are marked with the same reference numerals; and a detailed description is omitted as appropriate.

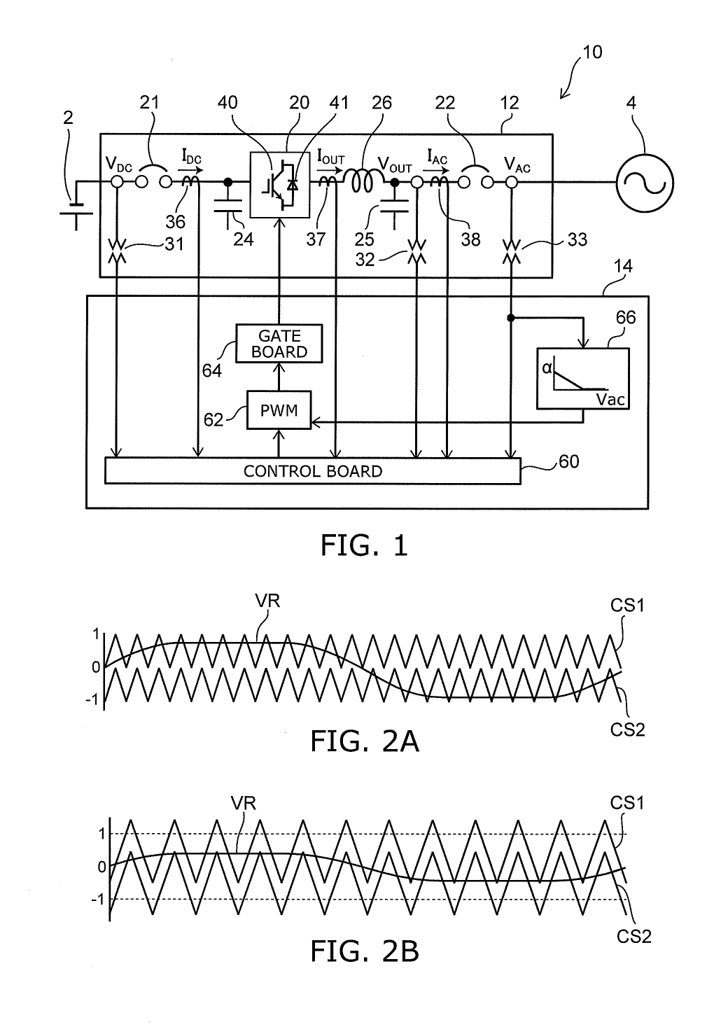

FIG. 1 is a block diagram schematically illustrating a system-connected inverter device according to an embodiment.

As illustrated in FIG. 1, the system-connected inverter device 10 includes a major circuit portion 12 and a controller 14. The major circuit portion 12 includes a three-level inverter 20, circuit breakers 21 and 22, filter capacitors 24 and 25, a filter reactor 26, voltage sensors 31 to 33, and current sensors 36 to 38.

The three-level inverter 20 is connected to a direct current power supply 2 via the circuit breaker 21. Also, the three-level inverter 20 is connected to an alternating current electric power system 4 via the circuit breaker 22. The three-level inverter 20 converts direct current power supplied from the direct current power supply 2 into alternating current power and supplies the alternating current power after the conversion to the electric power system 4.

The direct current power supply 2 is, for example, a solar power generator. In such a case, the system-connected inverter device 10 also may be called a power conditioner. The direct current power supply 2 is not limited to a solar power generator and may be any generator or power supply that can supply direct current power to the system-connected inverter device 10.

The alternating current power of the electric power system 4 may be single-phase alternating current power or may be three-phase alternating current power, etc. The three-level inverter 20 may convert the direct current power into single-phase alternating current power or may convert the direct current power into three-phase alternating current power.

The three-level inverter 20 converts the direct current power supplied from the direct current power supply 2 into the alternating current power by an ON/OFF of each of switching elements 40.

For example, based on a direct current voltage V_{DC} supplied from the direct current power supply 2, the three-level inverter 20 outputs a three-level voltage of 0 V, ½V_{DC}, and V_{DC}. More specifically, the voltages of −V_{DC}, −½V_{DC}, 0 V, ½V_{DC}, and V_{DC} are output. Thereby, the three-level inverter 20 converts the direct current power into the alternating current power. The circuit configuration of the three-level inverter 20 may be any circuit configuration that can output a three-level voltage.

Each of the switching elements 40 includes, for example, a self arc-extinguishing type semiconductor element such as a GTO (Gate Turn-Off thyristor), an IGBT (Insulated Gate Bipolar Transistor), etc. Each of the switching elements 40 includes a control terminal and a pair of major terminals. The control terminal is, for example, a gate terminal. Each of the switching elements 40 is switched between an ON state and an OFF state according to the voltage of the control terminal. The control terminal of each of the switching elements 40 is connected to the controller 14. The controller 14 controls the conversion from the direct current power into the alternating current power of the three-level inverter 20 by switching the ON/OFF of each of the switching elements 40.

The circuit breaker 21 is provided between the direct current power supply 2 and the three-level inverter 20. The circuit breaker 21 switches between a state in which the three-level inverter 20 is connected to the direct current power supply 2 and a state in which the three-level inverter 20 is cut off from the direct current power supply 2. The circuit breaker 22 is provided between the electric power system 4 and the three-level inverter 20. The circuit breaker 22 switches between a state in which the three-level inverter 20 is connected to the electric power system 4 and a state in which the three-level inverter 20 is cut off from the electric power system 4. The switching of the states of the circuit breakers 21 and 22 are controlled by, for example, the controller 14. For example, the circuit breakers 21 and 22 may automatically perform the switching of the states according to the current value, the voltage value, etc. The circuit breakers 21 and 22 each are provided as necessary and are omissible.

The filter capacitor 24 is provided between the direct current power supply 2 and the three-level inverter 20. In the example, the filter capacitor 24 is provided between the circuit breaker 21 and the three-level inverter 20. For example, the filter capacitor 24 suppresses noise included in the direct current power from the direct current power supply 2. In other words, the filter capacitor 24 smoothes the direct current voltage.

The filter capacitor 25 and the filter reactor 26 are provided between the electric power system 4 and the three-level inverter 20. In the example, the filter capacitor 25 and the filter reactor 26 are provided between the circuit breaker 22 and the three-level inverter 20.

One end of the filter reactor 26 is connected to the alternating current output terminal of the three-level inverter 20. The filter capacitor 25 and the filter reactor 26 suppress the harmonic components of an output voltage V_{OUT} and an output current I_{OUT} output from the three-level inverter 20 and cause the output voltage waveform and the output current waveform to better approach sine waves.

In the example, one filter capacitor 25 and one filter reactor 26 are illustrated for convenience. For example, in the case where the alternating current power of the electric power system 4 is three-phase alternating current power, the filter capacitor 25 and the filter reactor 26 are provided to correspond to each phase of the alternating current power. In other words, in the case of three-phase alternating current power, three of the filter capacitors 25 and three of the filter reactors 26 are provided.

The voltage sensor 31 is provided between the direct current power supply 2 and the circuit breaker 21. The voltage sensor 31 is connected to the controller 14. The voltage sensor 31 detects the direct current voltage V_{DC} of the direct current power supply 2 and inputs the detection result to the controller 14.

The voltage sensor 32 is provided between the filter reactor 26 and the circuit breaker 22. The voltage sensor 32 is connected to the controller 14. The voltage sensor 32 detects the output voltage V_{OUT} of the three-level inverter 20 and inputs the detection result to the controller 14.

The voltage sensor 33 is provided between the circuit breaker 22 and the electric power system 4. The voltage sensor 33 is connected to the controller 14. The voltage sensor 33 detects an alternating current voltage V_{AC} of the electric power system 4 and inputs the detection result to the controller 14.

Also, in the case where the output voltage V_{OUT} of the three-level inverter 20 and the alternating current voltage V_{AC} of the electric power system 4 are three-phase alternating current voltages, the voltage sensor 32 and the voltage sensor 33 detect the voltage value of each phase of the three-phase alternating current voltage and input the detection result to the controller 14.

The current sensor 36 is provided between the circuit breaker 21 and the three-level inverter 20. The current sensor 36 is connected to the controller 14. The current sensor 36 detects a direct current I_{DC} of the direct current power supply 2 and inputs the detection result to the controller 14.

The current sensor 37 is provided between the three-level inverter 20 and the filter reactor 26. The current sensor 37 is connected to the controller 14. The current sensor 37 detects the output current I_{OUT} of the three-level inverter 20 and inputs the detection result to the controller 14.

The current sensor 38 is provided between the filter reactor 26 and the circuit breaker 22. The current sensor 38 is connected to the controller 14. The current sensor 38 detects an alternating current I_{AC} of the electric power system 4 and inputs the detection result to the controller 14.

In the case where the output current I_{OUT} of the three-level inverter 20 and the alternating current I_{AC} of the electric power system 4 are three-phase alternating current, the current sensor 37 and the current sensor 38 detect the current value of each phase of the three-phase alternating current and input the detection result to the controller 14.

The controller 14 includes a control board 60, a PWM (Pulse Width Modulation) controller 62, a gate board 64, and an instantaneous drop detector 66. The detection results of the voltage sensors 31 to 33 and the current sensors 36 to 38 each are input to the control board 60. Also, the current command value of the output current I_{OUT} of the three-level inverter 20 is input to the control board 60. In other words, the current command value of the output current I_{OUT} is the current command value of the alternating current I_{AC} of the electric power system 4. The current command value is, for example, the effective converted value after d-q conversion. The current command value may be, for example, a signal having a sinusoidal waveform. The current command value may be a predetermined constant value or may be changed by an input from a higher-level controller, etc.

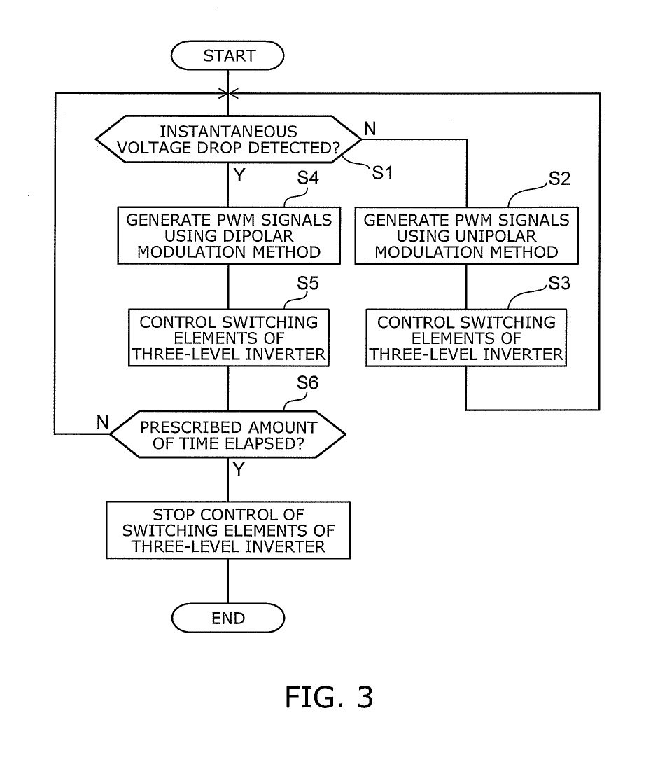

Based on the detection results of the voltage sensors 31 to 33, the detection results of the current sensors 36 to 38, and the current command value that are input, the control board 60 generates a voltage reference VR for causing the output current I_{OUT} to approach the current command value (referring to FIG. 2). Then, the control board 60 inputs the generated voltage reference VR to the PWM controller 62. The voltage reference VR is, for example, a signal having a sinusoidal waveform. In the case where the output of the three-level inverter 20 is three-phase alternating current power, the control board 60 generates the voltage reference VR for each phase.

Based on the voltage reference VR that is input, the PWM controller 62 generates a PWM signal for switching the ON/OFF of each of the switching elements 40 of the three-level inverter 20. The PWM controller 62 generates the PWM signals by comparing the voltage reference VR to carrier signals CS1 and CS2 (referring to FIG. 2). The carrier signals CS1 and CS2 are, for example, signals having triangular waveforms. For example, the PWM controller 62 generates multiple PWM signals corresponding respectively to the switching elements 40. The PWM controller 62 inputs, to the gate board 64, the PWM signals that are generated.

The gate board 64 is connected to the PWM controller 62 and connected to the control terminal of each of the switching elements 40. The gate board 64 generates multiple gate signals (drive signals) for each of the switching elements 40 from the input PWM signals and inputs the generated gate signals respectively to the control terminals of the switching elements 40. Thereby, the controller 14 controls the ON/OFF of each of the switching elements 40.

The detection result of the alternating current voltage V_{AC} of the electric power system 4 from the voltage sensor 33 is input to the instantaneous drop detector 66. Based on the detection result of the alternating current voltage V_{AC} that is input, the instantaneous drop detector 66 detects the instantaneous voltage drop of the electric power system 4 and inputs the detection result to the PWM controller 62. For example, in the case where the residual voltage of the alternating current voltage V_{AC} has become less than a first threshold, the instantaneous drop detector 66 detects the occurrence of the instantaneous voltage drop of the electric power system 4. For example, after detecting the instantaneous voltage drop, in the case where the residual voltage of the alternating current voltage V_{AC} becomes a second threshold or more, the instantaneous drop detector 66 detects the restoration from the instantaneous voltage drop of the electric power system 4.

The residual voltage is the proportion of the voltage after the drop to the voltage before the drop. The first threshold is, for example, 80%. The second threshold is, for example, 90%. For example, in the case where the residual voltage of the alternating current voltage V_{AC} has become less than 80%, the instantaneous drop detector 66 detects the occurrence of the instantaneous voltage drop of the electric power system 4; and in the case where the residual voltage becomes 90% or more, the instantaneous drop detector 66 detects the restoration from the instantaneous voltage drop of the electric power system 4. Thus, the second threshold is greater than the first threshold. In other words, the determination of the residual voltage of the alternating current voltage V_{AC} has hysteresis. Thereby, the undesirable switching of the output of the instantaneous drop detector 66 alternately between the detection state and the nondetection state of the instantaneous voltage drop can be suppressed. It is not always necessary for the determination of the residual voltage of the alternating current voltage V_{AC} to have hysteresis. The second threshold may be the same as the first threshold. It is sufficient for the second threshold to be the first threshold or more.

FIG. 2A and FIG. 2B are graphs schematically illustrating an example of the operation of the PWM controller according to the embodiment.

FIG. 2A schematically illustrates an example of the operation of the unipolar modulation method of the PWM controller 62. FIG. 2B schematically illustrates an example of the operation of the dipolar modulation method of the PWM controller 62.

The PWM controller 62 generates the PWM signals by using the unipolar modulation method and the dipolar modulation method and by switching between the methods.

As illustrated in FIG. 2A and FIG. 2B, the PWM controller 62 uses one voltage reference VR and two carrier signals CS1 and CS2 in each of the unipolar modulation method and the dipolar modulation method. The direct current bias component of the carrier signal CS2 is different from the direct current bias component of the carrier signal CS1. In other words, in the example, the unipolar modulation method is a double-carrier unipolar PWM method; and in other words, the dipolar modulation method is a double-carrier dipolar PWM method.

In the unipolar modulation method, the amplitudes of the carrier signals CS1 and CS2 are 0.5. Also, in the unipolar modulation method, the direct current bias component of the carrier signal CS1 is 0.5; and the direct current bias component of the carrier signal CS2 is −0.5.

In the dipolar modulation method, the amplitudes of the carrier signals CS1 and CS2 are 1.0. Also, in the dipolar modulation method, the direct current bias component of the carrier signal CS1 is 0.5; and the direct current bias component of the carrier signal CS2 is −0.5.

The amplitudes and the direct current bias components of the carrier signals CS1 and CS2 of the methods are not limited to those recited above and are settable arbitrarily in ranges in which the operation of the three-level inverter 20 is controllable. For example, the generation method of the PWM signals and the method for controlling the switching elements 40 of the three-level inverter 20 for the methods are described in more detail in Non-Patent Literature 1 recited above, etc.

The PWM controller 62 switches between the unipolar modulation method and the dipolar modulation method according to the detection result of the instantaneous drop detector 66. In the case where the instantaneous drop detector 66 does not detect the instantaneous voltage drop, the PWM controller 62 generates the PWM signals using the unipolar modulation method. Also, in the case where the instantaneous drop detector 66 detects the instantaneous voltage drop, the PWM controller 62 generates the PWM signals using the dipolar modulation method.

The PWM controller 62 switches from the unipolar modulation method to the dipolar modulation method according to the detection of the instantaneous voltage drop by the instantaneous drop detector 66 and switches from the dipolar modulation method to the unipolar modulation method according to the detection of the restoration from the instantaneous voltage drop.

For example, the PWM controller 62 switches between the unipolar modulation method and the dipolar modulation method by changing the amplitudes of the carrier signals CS1 and CS2. For example, the PWM controller 62 switches from the unipolar modulation method to the dipolar modulation method by changing the amplitudes of the carrier signals CS1 and CS2 from 0.5 to 1.0. At this time, for example, the PWM controller 62 gradually changes from the unipolar modulation method to the dipolar modulation method by monotonously increasing the amplitudes of the carrier signals CS1 and CS2 from 0.5 to 1.0 over a prescribed amount of time. Thereby, an abrupt change of the modulation method can be suppressed. For example, the generation of noise accompanying the abrupt change of the modulation method, etc., can be suppressed.

Similarly, for example, the PWM controller 62 gradually changes from the dipolar modulation method to the unipolar modulation method by monotonously reducing the amplitudes of the carrier signals CS1 and CS2 from 1.0 to 0.5 over a prescribed amount of time.

The switching between the unipolar modulation method and the dipolar modulation method is not limited to the amplitudes of the carrier signals CS1 and CS2 and may be performed using the direct current bias components of the carrier signals CS1 and CS2. For example, the PWM controller 62 switches between the unipolar modulation method and the dipolar modulation method using at least one of the amplitude or the direct current bias component for each of the carrier signals CS1 and CS2. For example, the amplitude of the voltage reference VR also may be changed in the switching between the unipolar modulation method and the dipolar modulation method.

For example, in the switching between the unipolar modulation method and the dipolar modulation method, the frequencies (the carrier frequencies) of the carrier signals CS1 and CS2 may be changed. For example, the frequencies of the carrier signals CS1 and CS2 in the dipolar modulation method are set to half of the frequencies of the carrier signals CS1 and CS2 in the unipolar modulation method. Thereby, for example, the switching frequencies of the switching elements 40 of the three-level inverter 20 can be substantially the same between the methods.

In the switching between the unipolar modulation method and the dipolar modulation method, at least one of the amplitude or the direct current bias component for each of the carrier signals CS1 and CS2 may be changed gradually as recited above or may be selectively switched between the value of the unipolar modulation method and the value of the dipolar modulation method. In the case where the at least one of the amplitude or the direct current bias component is changed gradually, the value of the at least one of the amplitude or the direct current bias component may be changed continuously or may be changed in stages.

Also, in the case where the at least one of the amplitude or the direct current bias component is changed gradually, it is favorable for the prescribed amount of time necessary to change each of the methods to be less than 0.1 seconds. For example, it is favorable for the prescribed amount of time to be not less than about 0.01 seconds but less than about 0.1 seconds.

FIG. 3 is a flowchart schematically illustrating an example of the method for operating the system-connected inverter device according to the embodiment.

As illustrated in FIG. 3, when starting the operation, the controller 14 of the system-connected inverter device 10 causes the instantaneous drop detector 66 to detect the instantaneous voltage drop (step S1 of FIG. 3). Based on the detection result of the alternating current voltage V_{AC} input from the voltage sensor 33, the instantaneous drop detector 66 detects the instantaneous voltage drop of the electric power system 4 and inputs the detection result to the PWM controller 62.

Also, when starting the operation, the controller 14 causes the control board 60 to start generating the voltage reference VR. Based on the detection results of the voltage sensors 31 to 33, the detection results of the current sensors 36 to 38, the current command value, etc., the control board 60 generates the voltage reference VR and inputs the voltage reference VR to the PWM controller 62.

In the case where the instantaneous voltage drop is not detected, the PWM controller 62 generates the PWM signals using the unipolar modulation method and inputs the PWM signals to the gate board 64 (step S2 of FIG. 3).

Based on the PWM signals that are input, the gate board 64 controls the ON/OFF of each of the switching elements 40 by generating the gate signals of the switching elements 40 of the three-level inverter 20 and by inputting the gate signals to the control terminals of the switching elements 40. In other words, the conversion from the direct current power to the alternating current power by the three-level inverter 20 is controlled (step S3 of FIG. 3).

In the case where the instantaneous voltage drop is not detected by the instantaneous drop detector 66, the controller 14 repeatedly executes the processing of step S1 to step S3 recited above. Thereby, the direct current power of the direct current power supply 2 is converted into alternating current power; and the alternating current power after the conversion is supplied to the electric power system 4.

On the other hand, in the case where the instantaneous voltage drop is detected by the instantaneous drop detector 66, the PWM controller 62 switches the modulation method from the unipolar modulation method to the dipolar modulation method. At this time, the PWM controller 62 gradually changes from the unipolar modulation method to the dipolar modulation method over a prescribed amount of time. Then, the PWM controller 62 generates the PWM signals using the dipolar modulation method and inputs the PWM signals to the gate board 64 (step S4 of FIG. 3).

Similarly to step S3, the gate board 64 controls the ON/OFF of each of the switching elements 40 by generating the gate signals of the switching elements 40 from the PWM signals (step S5 of FIG. 3). Thereby, the controller 14 provides the FRT function of continuing the operation even when the instantaneous voltage drop occurs. More specifically, a LVRT (Low Voltage Ride Through) function is provided.

In the case where the occurrence of the instantaneous voltage drop is detected by the instantaneous drop detector 66, the controller 14 starts timing from the timing of the detection of the instantaneous voltage drop and determines whether or not the prescribed amount of time has elapsed (step S6 of FIG. 3). The prescribed amount of time is, for example, 1 second.

In the case where the prescribed amount of time has not elapsed, the controller 14 returns to step S1. In the case where the instantaneous voltage drop continues, the processing of step S4 to step S6 is repeated; and the operation continuation for when the instantaneous voltage drop has occurred is executed. On the other hand, in the case where the restoration from the instantaneous voltage drop is detected before the prescribed amount of time has elapsed, the PWM controller 62 switches the modulation method from the dipolar modulation method to the unipolar modulation method and returns to the steady-state operation of step S1 to step S3.

In the case where it is determined that the prescribed amount of time has elapsed from the occurrence of the instantaneous voltage drop, the controller 14 stops the control of the switching elements 40 of the three-level inverter 20. In other words, in the case where the prescribed amount of time has elapsed from the detection of the voltage drop, the controller 14 determines that there is a system fault of the electric power system 4 and performs an error stop of the operation of the three-level inverter 20.

Thus, in the system-connected inverter device 10 according to the embodiment, the operations of the switching elements 40 of the three-level inverter 20 are controlled using the unipolar modulation method in the state in which the occurrence of the instantaneous voltage drop is not detected; and the operations of the switching elements 40 of the three-level inverter 20 are controlled using the dipolar modulation method in the state in which the occurrence of the instantaneous voltage drop is detected. In other words, in the state having the high modulation factor, the system-connected inverter device 10 uses the unipolar modulation method; and in the state having the low modulation factor, the system-connected inverter device 10 uses the dipolar modulation method. The modulation factor is the proportion of the direct current voltage and the alternating current voltage represented by V_{AC} (effective value)/V_{DC}.

In the case where the modulation factor is high (e.g., 0.5 or more) in the dipolar modulation method, the switching loss that accompanies the ON/OFF of each of the switching elements 40 undesirably increases compared to that of the unipolar modulation method. The system-connected inverter device 10 uses the unipolar modulation method in the state having the high modulation factor in which the occurrence of the instantaneous voltage drop is not detected. Thereby, in the system-connected inverter device 10, the increase of the switching loss of the steady-state operation can be suppressed.

Also, in the case where the modulation factor is low (e.g., less than 0.5) in the unipolar modulation method, low-order harmonics undesirably occur easily compared to the dipolar modulation method. The system-connected inverter device 10 uses the dipolar modulation method in the state having the low modulation factor in which the occurrence of the instantaneous voltage drop is detected. Thereby, in the system-connected inverter device 10, the occurrence of the harmonics in the FRT operation interval can be suppressed. For example, in the FRT operation interval as well, a waveform that is near a sine wave can be output; and a stable operation can be obtained.

Thus, in the system-connected inverter device 10 according to the embodiment, the unipolar modulation method and the dipolar modulation method are switched according to the detection result of the instantaneous voltage drop. Thereby, the switching loss can be suppressed; and a stable operation can be obtained.

For example, in the FRT function of solar power generation, it is desirable for the operation continuation to be performed without a gate block in the case of an instantaneous voltage drop in which the residual voltage is 20% or more and the duration is within 1 second, and for the output after the restoration of the voltage to be restored within 0.1 seconds to 80% or more of that before the voltage drop.

Conversely, in the system-connected inverter device 10, for example, the occurrence of the instantaneous voltage drop is detected in the case where the residual voltage has become less than 80%; the operation is continued by switching from the unipolar modulation method to the dipolar modulation method within 0.1 seconds from the detection of the instantaneous voltage drop; and in the case where the residual voltage becomes 90% or more, the restoration from the instantaneous voltage drop is detected; the switching from the dipolar modulation method to the unipolar modulation method is performed within 0.1 seconds from the detection of the restoration; and an alternating current voltage that is 80% or more of that before the voltage drop is output. Thereby, in the system-connected inverter device 10, the FRT function of the solar power generation can be satisfied.

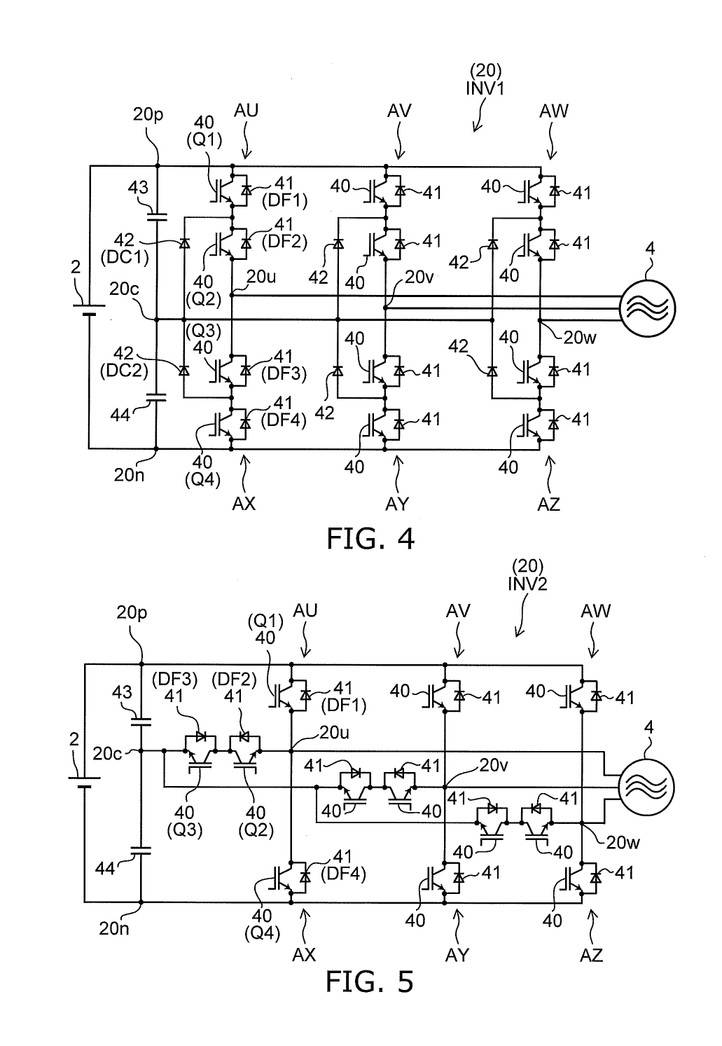

FIG. 4 is a block diagram schematically illustrating an example of the three-level inverter according to the embodiment. As illustrated in FIG. 4, a three-level inverter INV1 (20) includes the multiple switching elements 40, multiple rectifying elements 41 and 42, and multiple charge storage elements 43 and 44. In the example, the three-level inverter INV1 is a three-phase bridge-type. In the example, the alternating current power of the electric power system 4 and the alternating current power converted by the three-level inverter INV1 are three-phase alternating current power.

The three-level inverter INV1 includes direct current terminals 20p and 20n, alternating current terminals 20u, 20v, and 20w, and six arms AU, AV, AW, AX, AY, and AZ. The three-level inverter INV1 is connected to the direct current power supply 2 via the direct current terminals 20p and 20n. Also, the three-level inverter INV1 is connected to the electric power system 4 via the alternating current terminals 20u, 20v, and 20w.

The arms AU, AV, AW, AX, AY, and AZ each are provided between the direct current terminals 20p and 20n. In the three-level inverter INV1, the connection point between the arm AU and the arm AX, the connection point between the arm AV and the arm AY, and the connection point between the arm AW and the arm AZ respectively are the alternating current terminals 20u, 20v, and 20w.

In the example, the three-level inverter INV1 includes twelve switching elements 40, twelve rectifying elements 41, six rectifying elements 42, and two charge storage elements 43 and 44. The switching elements 40 have a three-phase bridge connection. The rectifying elements 41 respectively are connected in anti-parallel with the switching elements 40. The charge storage elements 43 and 44 are connected in series between the direct current terminals 20p and 20n. The charge storage elements 43 and 44 are, for example, condensers. Thereby, the connection point of the charge storage elements 43 and 44 is a neutral point 20c.

The configurations are substantially the same between the arms AU, AV, AW, AX, AY, and AZ of each phase connected to the alternating current terminals 20u, 20v, and 20w. Accordingly, here, the two arms AU and AX that are connected to the alternating current terminal 20u (the U-phase) are described as an illustration.

The arm AU that is on the positive side includes two switching elements Q1 and Q2 connected in series, rectifying elements DF1 and DF2 connected in anti-parallel respectively with the switching elements Q1 and Q2, and a rectifying element DC1 connected between the neutral point 20c and the series connection point of the switching elements Q1 and Q2.

Similarly, the arm AX that is on the negative side includes two switching elements Q3 and Q4 connected in series, rectifying elements DF3 and DF4 connected in anti-parallel respectively with the switching elements Q3 and Q4, and a rectifying element DC2 connected between the neutral point 20c and the series connection point of the switching elements Q3 and Q4.

The two arms AU and AX are connected in series between the direct current terminals 20p and 20n; and the series connection point of the two arms AU and AX is connected to the alternating current terminal 20u of the U-phase. The potential of the series connection point of the switching elements Q1 and Q2 is clamped to the neutral point potential via the rectifying element DC1. Similarly, the potential of the series connection point of the switching elements Q3 and Q4 is clamped to the neutral point potential via the rectifying element DC2. The rectifying elements DF1 to DF4 (the rectifying elements 41) are so-called reflux diodes. The rectifying elements DC1 and DC2 (the rectifying elements 42) are so-called clamp diodes.

The configurations of the arms AV and AW are substantially the same as the configuration of the arm AU. The configurations of the arms AY and AZ are substantially the same as the configuration of the arm AX. Thereby, the potentials of the alternating current terminals 20u, 20v, and 20w are clamped to the potential of one of the three levels of the direct current terminal 20p, the direct current terminal 20n, and the neutral point 20c according to the switching of the switching elements 40. The three-level inverter INV1 is a so-called neutral-point-clamped converter. The three-level inverter INV1 is a so-called NPC (NPC: Neutral-Point-Clamped) inverter.

In such a NPC-type three-level inverter INV1 as described above, the control is performed by switching between the unipolar modulation method and the dipolar modulation method according to the detection result of the instantaneous voltage drop. Thereby, the switching loss can be suppressed; and a stable operation can be obtained.

FIG. 5 is a block diagram schematically illustrating another example of the three-level inverter according to the embodiment.

As illustrated in FIG. 5, the three-level inverter INV2 (20) includes the multiple switching elements 40, the multiple rectifying elements 41, and the multiple charge storage elements 43 and 44. Compared to the three-level inverter INV1 described in reference to FIG. 4, the rectifying element 42 that functions as the clamp diode is omitted from the three-level inverter INV2. Components that are substantially the same functionally and configurationally as those of the three-level inverter INV1 described in reference to FIG. 4 are marked with the same reference numerals; and a detailed description is omitted.

In the example, one of the switching element Q1 or Q4 is provided in each of the arms AU and AX. Also, the two switching elements Q2 and Q3 that are connected in series are provided between the alternating current terminal 20u and the neutral point 20c.

The orientation of the current flowing in the switching element Q2 is the reverse of the orientation of the current flowing in the switching element Q3. When the switching element Q2 is set to the ON state, the orientation of the current flowing in the switching element Q2 is the direction from the neutral point 20c toward the alternating current terminal 20u. When the switching element Q3 is set to the ON state, the orientation of the current flowing in the switching element Q3 is the direction from the alternating current terminal 20u toward the neutral point 20c. In other words, the three-level inverter INV2 of the example is a so-called T-type NPC inverter.

In the three-level inverter INV2 as well, similarly to the three-level inverter INV1, the switching loss can be suppressed and a stable operation can be obtained by switching between the unipolar modulation method and the dipolar modulation method according to the detection result of the instantaneous voltage drop.

Thus, the three-level inverter 20 may have any circuit configuration that can output a three-level voltage and is applicable to a control using a unipolar modulation method and a control using a dipolar modulation method. The circuit configuration of the three-level inverter 20 is not limited to the three-level inverters INV1 and INV2 recited above and is modifiable as appropriate.

Hereinabove, embodiments of the invention are described with reference to specific examples. However, the embodiments of the invention are not limited to these specific examples. For example, one skilled in the art may similarly practice the invention by appropriately selecting specific configurations of components included in the system-connected inverter device such as the three-level inverter, the voltage sensor, the controller, etc., from known art; and such practice is within the scope of the invention to the extent that similar effects can be obtained.

Also, any two or more components of the specific examples may be combined within the extent of technical feasibility and are within the scope of the invention to the extent that the spirit of the invention is included.

Further, all system-connected inverter devices and methods for operating system-connected inverter devices practicable by an appropriate design modification by one skilled in the art based on the system-connected inverter devices and the methods for operating the system-connected inverter devices described above as the embodiments of the invention also are within the scope of the invention to the extent that the spirit of the invention is included.

Further, various modifications and alterations within the spirit of the invention will be readily apparent to those skilled in the art; and all such modifications and alterations should be seen as being within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A system-connected inverter device, comprising:
a three-level inverter including a plurality of switching elements, being connected to a direct current power supply and an electric power system, converting direct current power into alternating current power by an ON/OFF of the plurality of switching elements, and supplying the alternating current power to the electric power system, the electric power system being of alternating current, the direct current power being supplied from the direct current power supply;
a voltage sensor detecting an alternating current voltage of the electric power system; and
a controller detecting an instantaneous voltage drop of the electric power system based on a detection result of the voltage sensor, the controller controlling the converting by the three-level inverter from the direct current power into the alternating current power by controlling operations of the plurality of switching elements using a unipolar modulation method in a state in which the instantaneous voltage drop is not detected and by controlling the operations of the plurality of switching elements using a dipolar modulation method in a state in which the instantaneous voltage drop is detected.

2. The system-connected inverter device according to claim 1, wherein the controller gradually causes a change from the unipolar modulation method to the dipolar modulation method or from the dipolar modulation method to the unipolar modulation method by performing, for each of the unipolar modulation method and the dipolar modulation method, using a voltage reference and two carrier signals to compare the voltage reference to the two carrier signals to control the operations of the plurality of switching elements to cause at least one of an amplitude or a direct current bias component of each of the two carrier signals to change for a prescribed amount of time, the two carrier signals having triangular waveforms having different direct current bias components, the voltage reference having a sinusoidal waveform.

3. The system-connected inverter device according to claim 1, wherein
the controller detects an occurrence of the instantaneous voltage drop in the case where a residual voltage of the alternating current voltage detected by the voltage sensor becomes less than a first threshold, and after the detection of the instantaneous voltage drop, the controller detects a restoration from the instantaneous voltage drop in the case where the residual voltage of the alternating current voltage becomes a second threshold or more, and
the second threshold is greater than the first threshold.

4. The system-connected inverter device according to claim 1, wherein
the controller starts timing a prescribed amount of time from a timing of the detection of the instantaneous voltage drop, and
in the case where a restoration from the instantaneous voltage drop is detected before the prescribed amount of time has elapsed, the controller returns to a steady-state operation by switching from the dipolar modulation method to the unipolar modulation method, or in the case where the prescribed amount of time has elapsed, the controller stops the control of the plurality of switching elements.

5. A method for operating a system-connected inverter device, the system-connected inverter device including:
a three-level inverter including a plurality of switching elements, being connected to a direct current power supply and an electric power system, converting direct current power into alternating current power by an ON/OFF of the plurality of switching elements, and supplying the alternating current power to the electric power system, the electric power system being of alternating current, the direct current power being supplied from the direct current power supply; and
a voltage sensor detecting an alternating current voltage of the electric power system,
the method comprising:
detecting an instantaneous voltage drop of the electric power system based on a detection result of the voltage sensor; and
controlling the converting by the three-level inverter from the direct current power into the alternating current power by controlling operations of the plurality of switching elements using a unipolar modulation method in a state in which the instantaneous voltage drop is not detected and by controlling the operations of the plurality of switching elements using a dipolar modulation method in a state in which the instantaneous voltage drop is detected.
